(19) United States
(12) Patent Application Publication
(10) Pub. No.: US 2014/0368508 A1
(43) Pub. Date: Dec. 18, 2014

(54) ENHANCEMENT OF A PORTION OF VIDEO DATA RENDERED ON A DISPLAY UNIT ASSOCIATED WITH A DATA PROCESSING DEVICE BASED ON TRACKING MOVEMENT OF AN EYE OF A USER THEREOF

(71) Applicant: NVIDIA Corporation, Santa Clara, CA (US)

(72) Inventor: Trilok Chander Kunchakarra, Hyderabad (IN)

(73) Assignee: NVIDIA Corporation, Danta Clara, CA (US)

(21) Appl. No.: 13/920,094

(22) Filed: Jun. 18, 2013

(51) Int. Cl. G09G 5/30; G06F 3/01

(52) U.S. Cl. CPC G09G 5/30; G06F 3/013
USPC 345/428

(57) ABSTRACT

A method includes tracking, through a processor of a data processing device in conjunction with a number of sensors, a movement of an eye of a user of the data processing device onscreen on a display unit associated therewith. The processor is communicatively coupled to a memory. The method also includes determining, through the processor, a portion of a video data being rendered onscreen on the display unit on which the eye of the user is focused based on the sensed movement of the eye. Further, the method includes rendering, through the processor, the portion of the video data on the display unit at an enhanced level compared to other portions thereof following the determination of the portion of the video data.

### FIELD OF TECHNOLOGY

This disclosure relates generally to video post-processing and, more particularly, to a method, a device and/or a system of enhancement of a portion of video data rendered on a display unit associated with a data processing device based on tracking movement of an eye of a user thereof.

### BACKGROUND

A data processing device (e.g., a desktop computer, a laptop computer, a notebook computer, a smart television, a smart display, a netbook, a mobile device such as a mobile phone) may render video data on a display unit (e.g., Liquid Crystal Display (LCD), Light Emitting Diode (LED) display) associated therewith. A user of the data processing device may wish to modify a video parameter (e.g., a resolution) associated with the video data in order to enhance a viewing experience thereof. For the aforementioned purpose, the user may have to manually modify the video parameter associated with the video data through a physical intervention on the data processing device. Repeated manual modifications may frustrate the user. Further, as all onscreen portions of the display unit may have data associated therewith enhanced, the user may suffer eye strain during prolonged onscreen viewing.

### SUMMARY

Disclosed are a method, a device and/or a system of enhancement of a portion of video data rendered on a display unit associated with a data processing device based on tracking movement of an eye of a user thereof.

In one aspect, a method includes tracking, through a processor of a data processing device in conjunction with a number of sensors, a movement of an eye of a user of the data processing device onscreen on a display unit associated therewith. The processor is communicatively coupled to a memory. The method also includes determining, through the processor, a portion of a video data being rendered onscreen on the display unit on which the eye of the user is focused based on the sensed movement of the eye. Further, the method includes rendering, through the processor, the portion of the video data on the display unit at an enhanced level compared to other portions thereof following the determination of the portion of the video data.

In another aspect, a non-transitory medium, readable through a data processing device and including instructions embodied therein that are executable through the data processing device, is disclosed. The non-transitory medium includes instructions to track, through a processor of the data processing device in conjunction with a number of sensors, a movement of an eye of a user of the data processing device onscreen on a display unit associated therewith. The processor is communicatively coupled to a memory. The non-transitory medium also includes instructions to determine, through the processor, a portion of a video data being rendered onscreen on the display unit on which the eye of the user is focused based on the sensed movement of the eye. Further, the non-transitory medium includes instructions to render, through the processor, the portion of the video data on the display unit at an enhanced level compared to other portions thereof following the determination of the portion of the video data.

In yet another aspect, a data processing system is disclosed. The data processing system includes a data processing device. The data processing device includes a memory, a processor communicatively coupled to the memory, and a number of sensors. The processor is configured to execute instructions to track a movement of an eye of a user of the data processing device onscreen on a display unit associated therewith in conjunction with the number of sensors. The processor is further being configured to execute instructions to: determine a portion of a video data being rendered onscreen on the display unit on which the eye of the user is focused based on the sensed movement of the eye, and render the portion of the video data on the display unit at an enhanced level compared to other portions thereof following the determination of the portion of the video data.

The methods and systems disclosed herein may be implemented in any means for achieving various aspects, and may be executed in a form of a non-transitory machine-readable medium embodying a set of instructions that, when executed by a machine, cause the machine to perform any of the operations disclosed herein.

Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of a data processing device, according to one or more embodiments.

FIG. 2 is a schematic view of an example implementation of eye movement tracking in the data processing device of FIG. 1.

FIG. 3 is a schematic view of interaction between a driver component and a processor, a display unit and/or a number of sensors associated with the data processing device of FIG. 1, according to one or more embodiments.

FIG. 4 is a process flow diagram detailing the operations involved in enhancement of a portion of video data rendered on the display unit of the data processing device of FIG. 1 based on tracking a movement of an eye of a user thereof, according to one or more embodiments.

Other features of the present embodiments will be apparent from the accompanying drawings and from the detailed description that follows.

### DETAILED DESCRIPTION

Example embodiments, as described below, may be used to provide a method, a device and/or a system of enhancement of a portion of video data rendered on a display unit associated with a data processing device based on tracking movement of an eye of a user thereof. Although the present embodiments have been described with reference to specific example embodiments, it will be evident that various modifications and changes may be made to these embodiments without departing from the broader spirit and scope of the various embodiments.

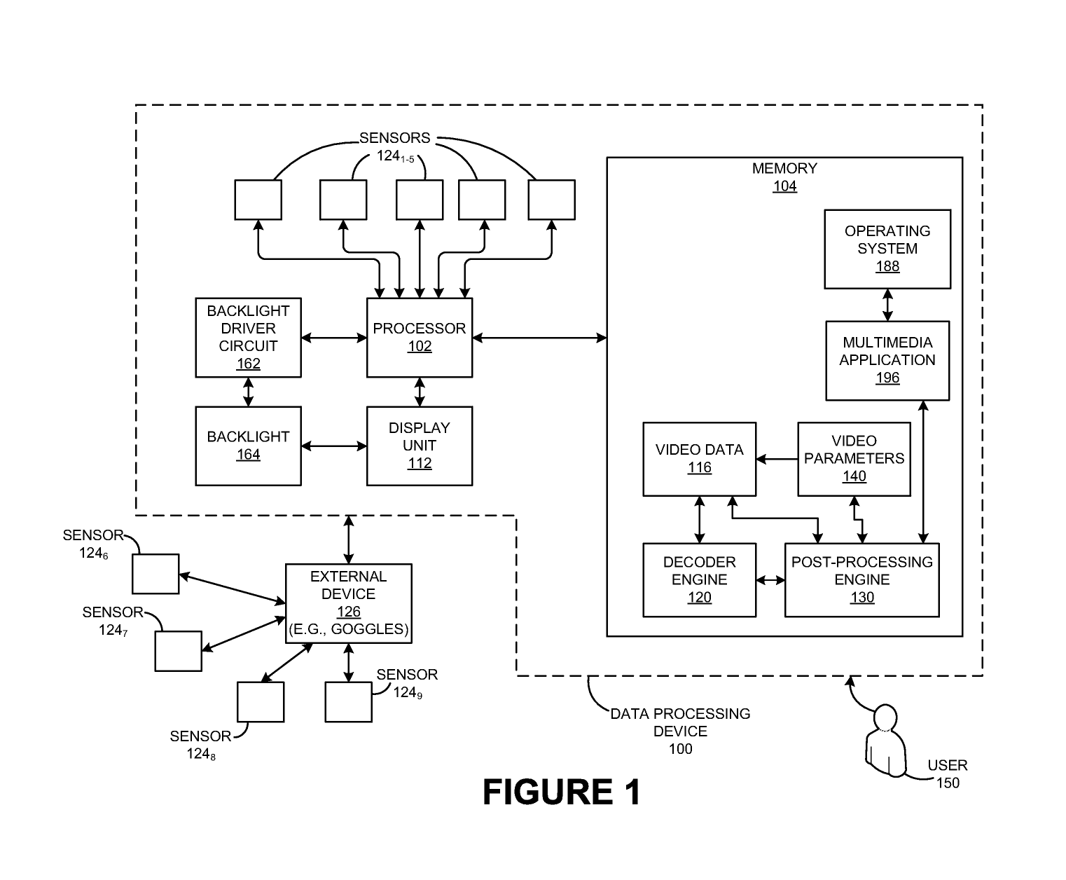

FIG. 1 shows a data processing device 100, according to one or more embodiments. In one or more embodiments, data processing device 100 may be a laptop computer, a desktop computer, a smart television, a smart display, a notebook computer, a netbook, a tablet or a mobile device such as a mobile phone. Other forms of data processing device 100 are within the scope of the exemplary embodiments discussed herein. In one or more embodiments, data processing device 100 may include a processor 102 (e.g., a Central Processing Unit (CPU), a Graphics Processing Unit (GPU)) communicatively coupled to a memory 104 (e.g., a volatile memory and/or a non-volatile memory); memory 104 may include storage locations configured to be addressable through processor 102.

In one or more embodiments, memory 104 of data processing device 100 may include video data 116 (e.g., video data 116 may be downloaded and locally stored in memory 104; video data 116 (e.g., a video stream, a file including video, audio and/or text content therein) may be transmitted from a data source) therein. In one or more embodiments, processor 102 may perform appropriate processing (e.g., data conversion) on video data 116 to enable rendering thereof on a display unit 112 associated with data processing device 100; FIG. 1 shows display unit 112 as being interfaced with processor 102. In one or more embodiments, processor 102 may execute a decoder engine 120 (e.g., a set of instructions) to decode video data 116 prior to rendering thereof on display unit 112. In one or more embodiments, a post-processing engine 130 may also execute on processor 102; post-processing engine 130 may be configured to receive an output of decoder engine 120 and one or more output(s) of a number of sensors 124₁₋₉ (to be discussed below) and perform appropriate processing thereon prior to rendering thereof on display unit 112 to reduce power consumption through data processing device 100, as will be discussed below.

In one or more alternate embodiments, post-processing engine 130 may be part of decoder engine 120; FIG. 1 shows post-processing engine 130 and decoder engine 120 separately merely for example purposes. FIG. 1 also shows parameters (e.g., video parameters 140) associated with video data 116 being stored in memory 104. Exemplary embodiments discussed herein may adapt video parameters 140 for a portion of video data 116 based on data sensed through sensors 124₁₋₉ to provide for power savings.

In one or more embodiments, as mentioned above, data processing device 100 may include a number of sensors 124₁₋₉ associated therewith to track an eye movement of a user 150 thereof. FIG. 1 shows five sensors 124₁₋₅ as being interfaced with processor 102 (e.g., through a sensor interface (not shown)) and four sensors 124₆₋₉ being interfaced with an external device 126 (e.g., a pair of goggles shown in FIG. 1) associated with data processing device 100. It should be noted that the aforementioned nine sensors are merely shown for example purposes. A system of sensors 124 associated with the exemplary embodiments may include less than nine sensors or more than nine sensors. Further, example implementations may not require external device 126 and the four sensors 124₆₋₉ associated therewith or sensors 124₁₋₅ (here, the external sensors 124₆₋₉ alone may be used).

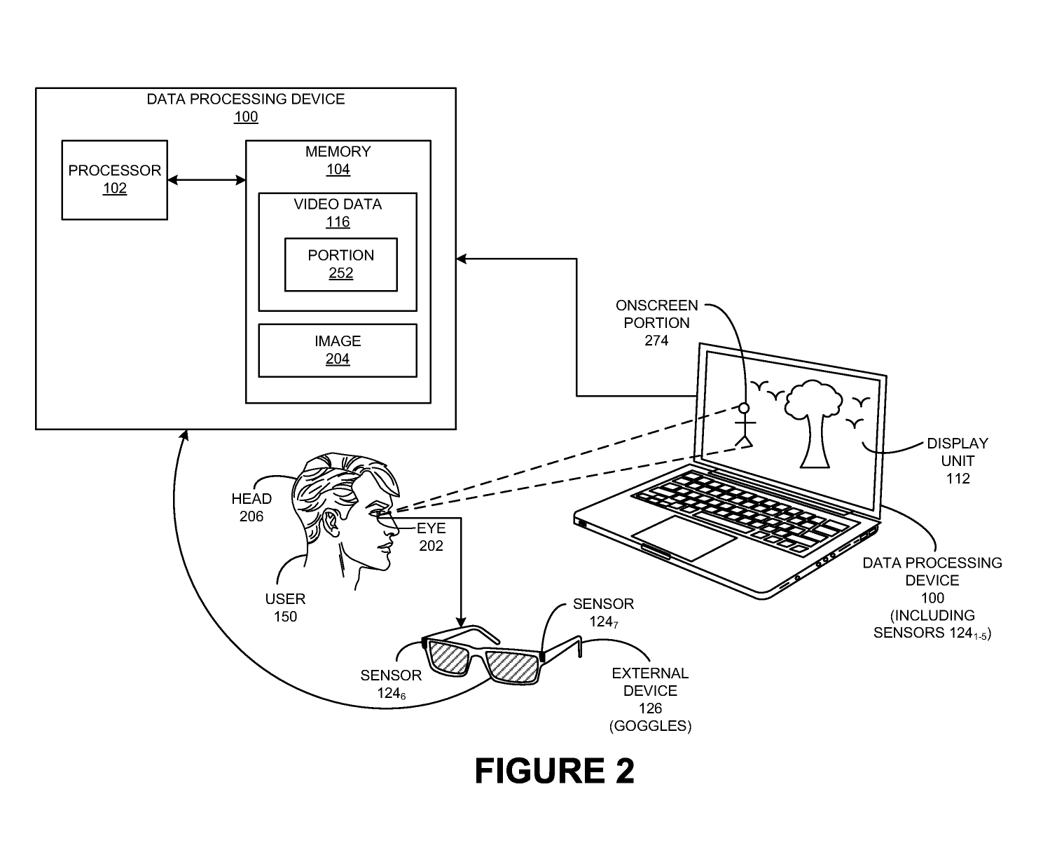

In one or more embodiments, sensors 124₁₋₉ may be configured to track the eye movement of user 150 as discussed above. FIG. 2 shows an example implementation of eye movement tracking in data processing device 100. Here, one or more of the five sensors 124₁₋₅ may be configured to emit light that is reflected from a retina of an eye 202 of user 150. The aforementioned one or more of the five sensors 124₁₋₅ or other sensors 124₁₋₅ may be an image sensor that is configured to enable recording an image 204 of eye 202 of user 150. Image 204 may then be analyzed through processor 102 to determine a position of a pupil of eye 202 based on pixel brightness distribution thereacross.

Also, FIG. 2 shows sensors 124₆₋₇ associated with external device 126 (e.g., a pair of goggles). The pair of goggles may be provided to enhance a viewing experience of user 150 on data processing device 100. Sensors 124₆₋₇ may be a combination of a motion sensor (e.g., an accelerometer) and an antenna to transmit a sensed movement of a head 206 of user 150. The data from sensors 124₆₋₇ (e.g., tracked head movement) may be utilized in conjunction with sensors 124₁₋₅ for accurate eye movement tracking purposes. In an alternate implementation, sensors 124₆₋₇ may solely be antennas configured to transmit an electromagnetic radiation to a receiver antenna (not shown) on data processing device 100. A distance between user 150 and a screen of display unit 112 may be determined based on the characteristics (e.g., electromagnetic field amplitudes) of the radiation pattern sensed.

It should be noted that other forms of sensors 124₁₋₅ and/or sensors 124₆₋₉ (e.g., sensors based on heat mapping, other forms of distance sensing/eye movement tracking) are within the scope of the exemplary embodiments discussed herein.

FIG. 2 shows a portion 252 of video data 116 in memory 104 to be rendered on display unit 112, according to one or more embodiments. In one or more embodiments, portion 252 may correspond to a portion of a screen of display unit 112 on which eye 202 (e.g., specifically pupil thereof) of user 150 is focused. In one or more embodiments, portion 252 may be determined through processor 102 based on the sensed data from sensors 124₁₋₉. In other words, in one or more embodiments, once sensors 124₁₋₉ detect an onscreen portion 274 of display unit 112 on which eye 202 of user 150 is focused, data associated therewith may be transmitted to processor 102. In one or more embodiments, processor 102 may be configured to analyze the data transmitted thereto (e.g., through executing post-processing engine 130), based on which portion 252 is determined from video data 116 in memory 104 (portion 252 may be determined from an output of decoder engine 120).

In one or more embodiments, once portion 252 is determined, processor 102 may be configured to adjust/enhance one or more video parameter(s) 140 (e.g., a resolution, color/contrast adjustment) associated with portion 252. In one or more embodiments, processor 102 may then be configured to enable rendering video data 116 on display unit 112 with adjusted/enhanced portion 252 thereon. It should be noted that enhancing/adjusting video parameter(s) 140 as discussed above alone may not determine the scope of the exemplary embodiments discussed herein. In an example embodiment, portion 252 may be rendered in a normal mode of operation and other portions of video data 116 may be rendered at a reduced level. Such variations are within the scope of the exemplary embodiments discussed herein. Further, rendering portion 252 at an enhanced level includes processing associated with increasing intensity level of a backlight 164 of display unit 112 on the corresponding area/portion on the “screen” thereof.

FIG. 1 shows a backlight driver circuit 162 of backlight 164 as being interfaced with processor 102. Upon determination of portion 252, processor 102 may be configured to transmit a control signal to backlight driver circuit 162 to increase the intensity level of backlight 164 for the portion “onscreen” corresponding to portion 252. Alternately, backlight driver circuit 162 may maintain the intensity level of backlight 164 for the portion “onscreen” corresponding to portion 252 and reduce the intensity for other portions.

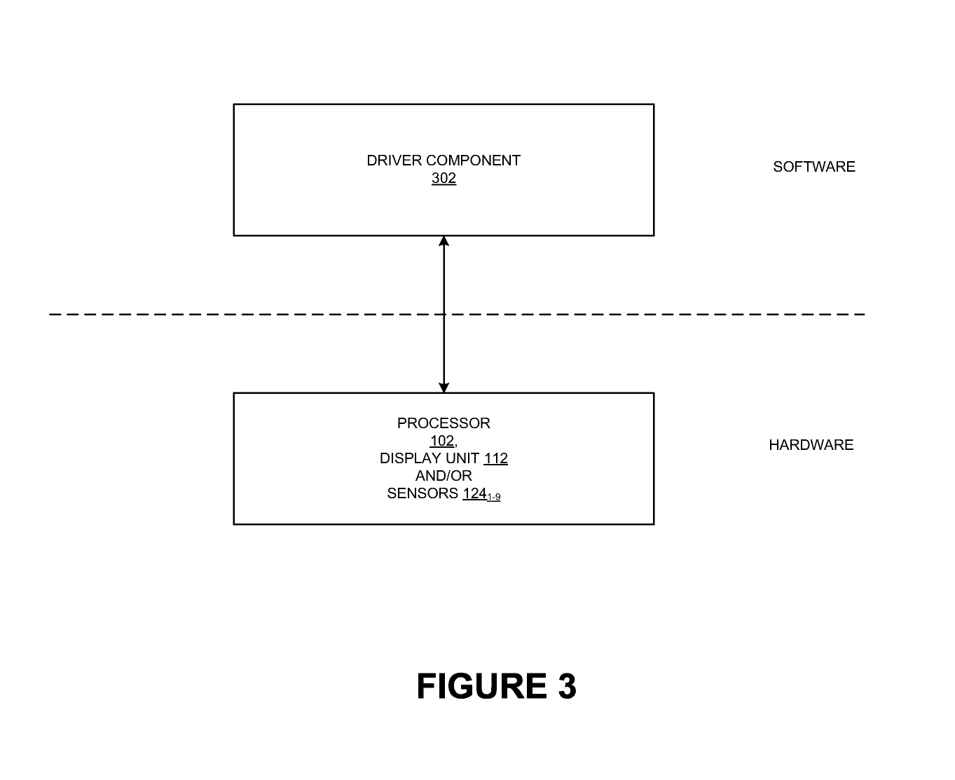

In one or more embodiments, the eye movement tracking, the determination of portion 252 and/or the rendering of portion 252 at an adjusted/enhanced level may be initiated through a driver component (e.g., a set of instructions) associated with processor 102, display unit 112 and/or sensors 124₁₋₉. FIG. 3 shows interaction between a driver component 302 and processor 102, display unit 112 and/or sensors 124₁₋₉, according to one or more embodiments. In one or more embodiments, driver component 302 may be configured to initiate the eye movement tracking, the determination of portion 252 and/or the rendering of portion 252 at an adjusted/enhanced level on display unit 112. An example scenario triggering the aforementioned processes may include user 150 switching data processing device 100 from an Alternating Current (AC) mode of operation to a battery mode of operation thereof. The aforementioned switching may be detected through processor 102 in conjunction with driver component 302. Alternately, processor 102 may be configured to periodically poll a battery (not shown) of data processing device 100 for the mode of operation thereof (or, processor 102 may obtain the mode of operation through an operating system 188 executing on data processing device 100). Once the battery mode is detected through driver component 302 in conjunction with processor 102, the processes discussed above may be initiated.

Also, user 150 may initiate the abovementioned processes through a physical button provided on data processing device 100 and/or a user interface of an application (e.g., multimedia application 196 shown as being part of memory 104) executing on data processing device 100. In one or more embodiments, driver component 302 may be packaged with operating system 188 (e.g., again, shown as being part of memory 104) executing on data processing device 100 and/or multimedia application 196. Further, instructions associated with driver component 302 and/or the processes discussed above may be tangibly embodied on a non-transitory medium (e.g., a Compact Disc (CD), a Digital Video Disc (DVD), a Blu-ray Disc®, a hard drive; appropriate instructions may be downloaded to the hard drive) readable through data processing device 100.

An example scenario in which concepts discussed herein may be applicable includes utilizing sensors 124₁₋₉ for eye movement tracking and dynamically increasing pixel brightness solely for the pixels corresponding to the portion onscreen on which eye 202 of user 150 is focused (the brightness of other portions may be maintained/reduced). It should be noted that rendering portion 252 on display unit 112 at an enhanced level discussed above may also include automatically providing user 150 a capability to perform operations on onscreen portion 274 (e.g., selecting a text corresponding to onscreen portion 274, cut/copy/paste actions associated therewith, modifying font size) based on tracking eye movement thereof, without a requirement on part of user 150 to physically intervene on data processing device 100. For example, user 150 may stare at the screen of display unit 112 for a time exceeding a threshold (e.g., 5 seconds); the aforementioned action may be predefined (e.g., through processor 102) as corresponding to an operation on onscreen portion 274 (e.g., a selecting a text corresponding to onscreen portion 274); once the abovementioned eye movement is tracked, the corresponding onscreen portion 274 may be determined and the operation performed thereon automatically without the requirement of physical intervention on part of user 150.

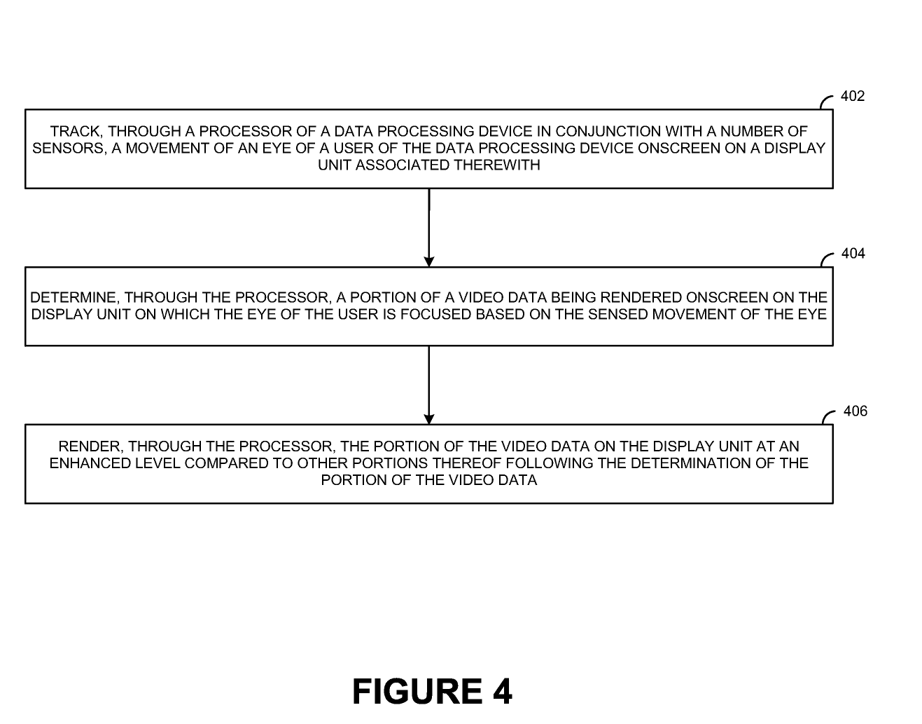

FIG. 4 shows a process flow diagram detailing the operations involved in enhancement of portion 252 of video data 116 rendered on display unit 112 associated with data processing device 100 based on tracking a movement of eye 202 of user 150, according to one or more embodiments. In one or more embodiments, operation 402 may involve tracking, through processor 102 in conjunction with sensors 124₁₋₉, a movement of eye 202 onscreen on display unit 112. In one or more embodiments, processor 102 may be communicatively coupled to memory 104. In one or more embodiments, operation 404 may involve determining, through processor 102, portion 252 of video data 116 being rendered onscreen on display unit 112 on which eye 202 is focused based on the sensed movement of eye 202. In one or more embodiments, operation 406 may then involve rendering, through processor 102, portion 252 on display unit 112 at an enhanced level compared to other portions of video data 116 following the determination of portion 252.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a non-transitory machine-readable medium). For example, the various electrical structure and methods may be embodied using transistors, logic gates, and electrical circuits (e.g., application specific integrated (ASIC) circuitry and/or Digital Signal Processor (DSP) circuitry).

In addition, it will be appreciated that the various operations, processes and methods disclosed herein may be embodied in a non-transitory machine-readable medium and/or a machine-accessible medium compatible with a data processing system (e.g., data processing device 100). Accordingly, the specification and drawings are to be regarded in an illustrative rather than a restrictive sense.

What is claimed is:

1. A method comprising:
tracking, through a processor of a data processing device in conjunction with a plurality of sensors, a movement of an eye of a user of the data processing device onscreen on a display unit associated therewith, the processor being communicatively coupled to a memory;
determining, through the processor, a portion of a video data being rendered onscreen on the display unit on which the eye of the user is focused based on the sensed movement of the eye; and
rendering, through the processor, the portion of the video data on the display unit at an enhanced level compared to other portions thereof following the determination of the portion of the video data.

2. The method of claim 1, comprising tracking the movement of the eye through at least one of:
tracking a movement of a pupil of the eye of the user through the plurality of sensors; and
utilizing at least one other sensor of the plurality of sensors to track another parameter for use in conjunction with the tracked movement of the eye of the user to increase accuracy of the tracking of the movement of the eye.

3. The method of claim 1, wherein rendering the portion of the video data at the enhanced level includes at least one of:
adjusting at least one video parameter associated with the portion;
transmitting a control signal to a backlight driver circuit of a backlight of the display unit to adjust an intensity level of the backlight corresponding to at least one of the portion of the video data and the other portions thereof; and
providing the user a capability to perform an operation on the portion without a requirement of physical intervention on the data processing device on behalf thereof.

4. The method of claim 1, further comprising initiating at least one of the tracking of the movement of the eye, the determination of the portion and the rendering thereof at the enhanced level through a driver component associated with at least one of the processor, the display unit and the plurality of sensors.

5. The method of claim 4, comprising providing the driver component through at least one of: packaging thereof with an operating system executing on the data processing device and packaging thereof with an application executing on the data processing device.

6. The method of claim 4, further comprising triggering the initiation of the at least one of the tracking of the movement of the eye, the determination of the portion and the rendering thereof upon at least one of: detection of a battery mode of operation of the data processing device, the user depressing a physical button on the data processing device and user initiation through a user interface of a multimedia application executing on the data processing device.

7. The method of claim 1, comprising providing at least one sensor associated with the data processing device and at least one sensor associated with a device external to the data processing device as the plurality of sensors.

8. A non-transitory medium, readable through a data processing device and including instructions embodied therein that are executable through the data processing device, comprising:
instructions to track, through a processor of the data processing device in conjunction with a plurality of sensors, a movement of an eye of a user of the data processing device onscreen on a display unit associated therewith, the processor being communicatively coupled to a memory;
instructions to determine, through the processor, a portion of a video data being rendered onscreen on the display unit on which the eye of the user is focused based on the sensed movement of the eye; and
instructions to render, through the processor, the portion of the video data on the display unit at an enhanced level compared to other portions thereof following the determination of the portion of the video data.

9. The non-transitory medium of claim 8, wherein the instructions to track the movement of the eye include at least one of:
instructions to track a movement of a pupil of the eye of the user through the plurality of sensors; and
instructions to utilize at least one other sensor of the plurality of sensors to track another parameter for use in conjunction with the tracked movement of the eye of the user to increase accuracy of the tracking of the movement of the eye.

10. The non-transitory medium of claim 8, wherein the instructions to render the portion of the video data at the enhanced level include at least one of:
instructions to adjust at least one video parameter associated with the portion;
instructions to transmit a control signal to a backlight driver circuit of a backlight of the display unit to adjust an intensity level of the backlight corresponding to at least one of the portion of the video data and the other portions thereof; and
instructions to provide the user a capability to perform an operation on the portion without a requirement of physical intervention on the data processing device on behalf thereof.

11. The non-transitory medium of claim 8, further comprising instructions to initiate at least one of the tracking of the movement of the eye, the determination of the portion and the rendering thereof at the enhanced level through a driver component associated with at least one of the processor, the display unit and the plurality of sensors.

12. The non-transitory medium of claim 11, further comprising instructions to trigger the initiation of the at least one of the tracking of the movement of the eye, the determination of the portion and the rendering thereof upon at least one of: detection of a battery mode of operation of the data processing device, the user depressing a physical button on the data processing device and user initiation through a user interface of a multimedia application executing on the data processing device.

13. The non-transitory medium of claim 8, comprising instructions compatible with at least one sensor of the plurality of sensors associated with a device external to the data processing device.

14. A data processing system comprising:
a data processing device comprising:
a memory;
a processor communicatively coupled to the memory; and
a plurality of sensors, the processor being configured to execute instructions to track a movement of an eye of a user of the data processing device onscreen on a display unit associated therewith in conjunction with the plurality of sensors, and the processor further being configured to execute instructions to:
determine a portion of a video data being rendered onscreen on the display unit on which the eye of the user is focused based on the sensed movement of the eye, and
render the portion of the video data on the display unit at an enhanced level compared to other portions thereof following the determination of the portion of the video data.

15. The data processing system of claim 14, wherein the processor, in conjunction with the plurality of sensors, is configured to track the movement of the eye based on at least one of:
tracking a movement of a pupil of the eye of the user through the plurality of sensors, and
utilizing at least one other sensor of the plurality of sensors to track another parameter for use in conjunction with the tracked movement of the eye of the user to increase accuracy of the tracking of the movement of the eye.

16. The data processing system of claim 14, wherein the processor is configured to enable rendering the portion of the video data at the enhanced level based on at least one of:
adjusting at least one video parameter associated with the portion,
transmitting a control signal to a backlight driver circuit of a backlight of the display unit to adjust an intensity level of the backlight corresponding to at least one of the portion of the video data and the other portions thereof, and
providing the user a capability to perform an operation on the portion without a requirement of physical intervention on the data processing device on behalf thereof.

17. The data processing system of claim 14, further comprising a driver component associated with at least one of the processor, the display unit and the plurality of sensors to initiate at least one of the tracking of the movement of the eye, the determination of the portion and the rendering thereof at the enhanced level.

18. The data processing system of claim 17, wherein the driver component is at least one of: packaged with an operating system executing on the data processing device and packaged with an application executing on the data processing device.

19. The data processing system of claim 17, wherein the initiation of the at least one of the tracking of the movement of the eye, the determination of the portion and the rendering thereof is triggered upon at least one of: detection of a battery mode of operation of the data processing device, the user depressing a physical button on the data processing device and user initiation through a user interface of a multimedia application executing on the data processing device.

20. The data processing system of claim 14, further comprising a device external to the data processing device, the external device including at least one sensor of the plurality of sensors.
